(19) United States
(12) Patent Application Publication
(10) Pub. No.: US 2019/0013527 A1
(43) Pub. Date: Jan. 10, 2019

(54) ELECTRO-CHEMICAL MODULE

(71) Applicant: PLANSEE SE

(72) Inventors: WOLFGANG SCHAFBAUER, REUTTE (AT); MARKUS KOEGL, VILS (AT); MATTHIAS RUETTINGER, REUTTE (AT); CHRISTIAN BIENERT, REUTTE (AT); MARCO BRANDNER, WALTENHOFEN (DE)

(21) Appl. No.: 15/745,184

(22) PCT Filed: Jun. 29, 2016
(86) PCT No.: PCT/AT2016/000073

§ 371 Date: Jan. 16, 2018

(30) Foreign Application Priority Data
Jul. 14, 2015 (AT) GM 209/2015

(51) Int. Cl. H01M 8/0232; H01M 8/0273; H01M 8/0286; H01M 8/1226

(52) U.S. Cl. CPC H01M 8/0232; H01M 8/0273; H01M 2008/1293; H01M 8/1226; H01M 8/0286

(57) ABSTRACT

An electro-chemical module has a porous plate-shaped metallic carrier substrate with a gas-permeable central region and a peripheral region. A layered construction is disposed in the central region on a first side of the carrier substrate. At least one metallic gas-tight housing part is by way of a welded connection connected to the peripheral region of the carrier substrate. A gas-tight zone extends from the layered construction up to the housing part. The gas-tight zone has a gas-tight surface portion which extends superficially from the layered construction on the first side of the carrier substrate at least up to the welded connection. The welded connection by which the gas-tight surface portion is connected in a gas-tight manner to the housing part and the welding zone of which extends only through part of the thickness of the carrier substrate.

The present invention relates to an electro-chemical module, in particular to a fuel cell module, which has a porous plate-shaped metallic carrier substrate having a gas-permeable central region and a peripheral region surrounding the central region; a layered construction having at least one electro-chemically active layer which is disposed in the central region on a first side of the carrier substrate; at least one metallic gas-tight housing part which by way of a welded connection is connected to the peripheral region of the carrier substrate; and a gas -tight zone extending from the layered construction up to the gas-tight housing part.

The electro-chemical module according to the invention is employable inter alia as a high-temperature fuel cell or as a solid oxide fuel cell (SOFC), as a solid oxide electrolyser cell (SOEC), and as a reversible solid oxide fuel cell (R-SOFC). A mechanically supportive component which may be formed, for example, by one of the electro -chemically active layers of the layered construction, such as, for example, by an electrolyte, an anode, or a cathode of the functional layers which in this instance are configured in a correspondingly thick manner, or by a component which is configured so as to be separate by one of these functional layers, such as, for example, by a ceramic or metallic carrier substrate, is required for the layers of the layered construction that are configured so as to be comparatively thin. The present invention relates to the latter concept having a separately configured metallic carrier substrate which forms the supporting function for the layers of the layered construction. Metal substrate supported systems (MSC—metal supported cells) of this type in terms of thermal and redox cyclability and in terms of mechanical stability are advantageous. In that the electrolyte, of which the electrical resistance drops as the thickness is reduced and the temperature is increased, in the case of MSCs may be configured so as to be comparatively thin (for example, having a thickness in the range of 2 to 10 μm, preferably in the range of 3 to 5 μm), MSCs may be operated at a comparatively low operating temperature of approx. 600° C. to 800° C. (while SOFCs in some instances are operated at operating temperatures of up to 1000° C.). By virtue of their specific advantages, MSCs are suitable in particular for mobile applications such as, for example, for supplying electrical power to passenger motor vehicles or to commercial motor vehicles (APU—auxiliary power unit).

In comparison with fully ceramic systems, these metal -ceramic MSC systems (i.e. a metallic carrier substrate having at least in proportions a ceramic layered construction) are distinguished by significantly reduced material costs and by new potentials in terms of stack integration in that the metallic carrier substrate enables bonding by means of soldering/brazing and welding processes, which are cost-effective and very durable connection techniques. In the context of stack integration, the individual metal substrate supported cells specifically need to be connected to respective (metallic) housing parts (for example, a sheet-metal frame plate, an interconnector, etc.), disposed on top of one another in a stack, and to be interconnected electrically in series. In the case of the individual cells of the stack, the housing parts provide the respective dedicated gas supply of the process gases, in the case of a fuel cell meaning the supply of the fuel to the anode and of the oxidation means to the cathode, and the discharge of the gases which are created in the electro-chemical reaction. Furthermore, the electrical interconnection of the individual cells of a stack in series is performed by way of these housing parts.

The reliable gas-tight separation of the two process-gas spaces which in relation to one cell are configured on either side of the electrolyte is essential for the functionality of the individual cells. A considerable challenge in particular lies in the bonding of the metal substrate supported cell to the contiguous housing part(s), as the transition region from the layered construction, the electrolyte establishing the process-gas separation in the region of said layered construction, up to the contiguous housing part(s) is to be configured in a gas-tight manner (at least in respect of the process gases and the gases created), this gas-tightness having to be guaranteed for extended durations of employment, with mechanical stresses and temperature variations arising.

A method for manufacturing a fuel cell, in which a metallic carrier substrate having gas-passage openings which are provided in the peripheral region is obtained in that a planar porous body is powder-metallurgically manufactured, the peripheral region of the body by uniaxial pressing or rolling is compressed up to reaching gas-tightness, and is provided with gas-passage openings, is known from EP 2 174 371 B1. The layered construction having electro -chemically active layers is applied in the central porous region of the metallic carrier substrate. An assembly in which a metallic carrier substrate is configured so as to be gas-permeable and has a gas-tight zone which extends through the entire thickness of the substrate and is fixed to a housing by welding and/or soldering/brazing is described in EP 1 278 259 B1.

Accordingly, the object of the present invention lies in providing in a cost-effective manner an electro-chemical module having a metallic carrier substrate and a layered construction having at least one electro-chemically active layer, which is disposed in a central porous region of the carrier substrate, wherein a transition region between the layered construction and a housing part which is contiguous the carrier substrate is configured so as to be gas -tight at least to the process gases and to the gases created, this gas tightness being guaranteed over long durations of employment, even in the case of mechanical stresses and temperature variations.

This object is achieved by an electro-chemical module according to claim 1, and by a method for manufacturing an electro-chemical module, according to claim 15. Advantageous refinements of the invention are stated in the dependent claims.

According to the present invention, the electro-chemical module has a porous plate-shaped metallic carrier substrate having (in relation to the plane of primary extent thereof) a gas-permeable central region and a peripheral region surrounding the central region;

a layered construction having at least one, in particular at least two, electro-chemically active layer(s), which layered construction is disposed in the central region on a first side of the carrier substrate; at least one metallic gas-tight housing part which by way of a welded connection is connected to the peripheral region of the carrier substrate; and a gas-tight zone extending from the layered construction (at least) up to the gas-tight housing part. The gas-tight zone here has a gas-tight surface portion which extends superficially from the layered construction on the first side (i.e. the side facing the layered construction) of the carrier substrate (at least) up to the welded connection; and the welded connection by which the gas-tight surface portion is connected in a gas-tight manner to the housing part and the welding zone of which, proceeding from the first side, in the thickness direction extends only through part of the thickness of the carrier substrate to an opposite second side of the carrier substrate.

In that, according to the invention, the gas-tight zone extends only superficially on the first side of the carrier substrate it is possible according to the present invention for a carrier substrate which is powder-metallurgically manufactured in an integral manner and which in the peripheral region is not to be compressed to reach gas tightness to be used. Specifically in the case of materials which are difficult to press, such as formed by chromium-based alloys or by alloys which have a significant proportion of chromium, considerably lower pressing forces are required on account thereof, manufacturing costs being saved and the proportion of waste being reduced as a result. Furthermore, more constant material properties are achieved along the plane of primary extent of the carrier substrate, on account of which the risk of fissuring and warping, in particular at high temperature variations and/or mechanical stresses is reduced. In that the welding zone, proceeding from the first side, extends only through part of the thickness of the carrier substrate, the welded connection also only initiates a comparatively minor variation in the material properties within the carrier substrate. Accordingly, it is ensured that the advantageous material properties of the carrier substrate that are obtained by way of the powder-metallurgical manufacturing process are largely maintained. By contrast, if the welding zone (which is configured so as to be gas tight) would extend through the entire thickness of the carrier substrate, a considerably higher energy input would be required during welding of the carrier substrate by virtue of the comparatively large welding zone required. A design embodiment of this type would not only lead to increased production costs but also to greater warping of the components, to a coarsening of the grain in the microstructure of the regions contiguous to the welding zone which has a detrimental effect on the material properties, and to the risk of fissuring or even of rupture in the case of mechanical and/or thermal stress in the region of the welding zone.

Apart from the preferred application as a high-temperature fuel cell or as a solid oxide fuel cell (SOFC), the electro-chemical module according to the invention is also employable as a solid oxide electrolyser cell (SOEC), and as a reversible solid oxide fuel cell (R-SOFC). The construction and the functioning of metal substrate supported high-temperature fuel cells (SOFCs), as are implementable using the electro-chemical module according to the invention, will be discussed hereunder. Such metal substrate supported SOFCs form the preferred application for the electro-chemical module according to the invention. A metal substrate supported cell (MSC) is composed of a porous plate-shaped metallic carrier substrate having a preferred thickness in the range of 170 μm to 1.5 mm, in particular in the range of 250 μm to 800 μm, on which in a gas-permeable central region a layered construction having the anode, the electrolyte, and the cathode as electro-chemically active layers and optionally having further layers (for example, diffusion barriers of, for example, cerium-gadolinium oxide or lanthanum-chromium oxide, etc., between the carrier substrate and the anode, a diffusion barrier of, for example, cer-gadolinium oxide between the electrolyte and the cathode) is applied. In the case of the electro-chemical module according to the invention, not all electro-chemically active layers need to be applied here; rather, the layered construction may also have only one electro-chemically active layer (for example, the anode), preferably two electro-chemically active layers (for example, the anode and the electrolyte), the further layers, in particular those for completing an electro -chemical cell, being applied only subsequently. The application of the layers of the layered stack is preferably performed by means of PVD (physical vapour deposition), for example by sputtering, and/or by means of thermal coating methods, for example flame spraying or plasma spraying, and/or by wet-chemical methods, such as, for example, screen printing, wet powder coating, etc., wherein a plurality of these methods may also be employed in combination in order for the entire layered construction of an electro-chemical cell to be implemented. Preferably, the anode is that electro-chemically active layer that is next to the carrier substrate, while the cathode is configured on that side of the electrolyte that faces away from the carrier substrate. Alternatively, however, a reversed arrangement of the two electrodes is also possible.

Both the anode (formed from a composite composed of nickel and zirconium dioxide fully stabilized with yttrium oxide, for example) as well as the cathode (formed from perovskites with mixed conductivity, such as (La,Sr)(Co,Fe)O₃, for example) are configured so as to be gas-permeable. A gas-tight solid electrolyte from a solid ceramic material from metal oxide (for example, from zirconium dioxide fully stabilized with yttrium oxide), which is conductive to oxygen ions but not to electrons, is configured between the anode and the cathode. Alternatively, the solid electrolyte may also be conductive to protons but not to electrons, this relating to the younger generation of SOFCs (for example, a solid electrolyte from metal oxide, in particular from barium -zirconium oxide, barium-cerium oxide, lanthanum-tungsten oxide, or lanthanum-niobium oxide). During operation of the SOFC the anode is supplied with fuel (for example, hydrogen or conventional hydrocarbons such as methane, natural gas, biogas, etc., optionally in a complete or a partially prereformed state), said fuel in the anode being oxidized in a catalytic manner while discharging electrons. The electrons are diverted from the fuel cell and by way of an electrical consumer flow to the cathode. An oxidizing means (for example, oxygen or air) is reduced by absorbing the electrons at the cathode. The electrical circuit is closed in that in the case of an electrolyte which is conductive to oxygen ions, the oxygen ions which are created at the cathode by way of the electrolyte flow to the anode and react with the fuel on the respective interfaces.

In the case of a solid oxide electrolyser cell (SOEC) in which a redox reaction is forced while employing an electric current, such as for example a conversion of water to hydrogen and oxygen, the metal substrate supported cell (MSC) is configured so as to correspond to the construction explained here above. Here, the layer which here above has been described with reference to the SOFC as the anode, corresponds to the cathode, and vice-versa. A reversible solid oxide fuel cell (R-SOFC) is operatable both as an SOEC as well as an SOFC.

In the present context, “gas tight” means in particular that the leakage rate at sufficient gas tightness as a standard is <10⁻³ hPa*dm³/cm²s (hPa: hectopascal, dm³: cubic decimetre, cm²: square centimetre, s: second) (measured under air using the pressure-increase method and the measuring apparatus of the Dr. Wiesner company, Remscheid, type: Integra DDV, at a pressure differential dp=100 hPa). A gas tightness of this type is implemented in particular in the region of the gas-tight zone and in the region of the layered construction.

The peripheral region is disposed in particular in an encircling manner around the gas-permeable central region. The at least one housing part which, for example, may be configured as a sheet-metal plate part from steel types having a high chromium content (commercially available, for example, under the trade names Crofer® 22 H, Crofer® 22 APU, ZMG® 232L), preferably likewise extends in an encircling manner around the peripheral region and along the entire circumference of the peripheral region is connected to the latter by way of the welded connection. The welding zone which is formed by a fused structure and which according to the invention extends only through part of the thickness of the carrier substrate is identifiable, for example, by means of a micrograph which is produced in the cross section through the welded connection under an illuminated microscope or under a scanning electron microscope (SEM).

According to one refinement, the central region and the peripheral region are configured in a monolithic manner, that is to say integrally, this being understood to mean that these are not a plurality of interconnected components, optionally also interconnected by way of a materially integral connection (for example, soldering/brazing, welding, etc.). According to one refinement, the carrier substrate is integrally manufactured by powder metallurgical means from a material combination which is based on Cr (chromium) and/or Fe (iron), that is to say that the proportion of Cr and of Fe in total are at least 50% of weight. The powder -metallurgical and integral manufacture is identifiable by means of the microstructure of the carrier substrate which below the gas-tight zone across the entire plane of primary extent thereof has a typical sintered structure in which the individual grains, depending on the degree of sintering, are interconnected by more or less pronounced sintering necks. In particular, the proportion of Cr and of Fe in total is at least 80% of weight, preferably at least 90% of weight. In particular, the carrier substrate may be manufactured according to AT 008 975 U1, and thus be composed of an Fe-based alloy having Fe >50% of weight, and 15 to 35% of weight Cr; 0.01 to 2% of weight of one or a plurality of elements from the group Ti (titanium), Zr (zirconium), Hf (hafnium), Mn (manganese), Y (yttrium), Sc (scandium), rare-earth metals; 0 to 10% of weight Mo (molybdenum) and/or Al (aluminium); 0 to 5% of weight of one or a plurality of metals from the group Ni (nickel), W (tungsten), Nb (niobium), Ta (tantalum); 0.1 to 1% of weight O (oxygen); the remainder being Fe and impurities, wherein at least one metal from the group Y, Sc, rare-earth metals, and at least one metal from the group Cr, Ti, Al, Mn form a mixed oxide. In order for the carrier substrate to be formed, a powder fraction having a particle size <150 μm, in particular <100 μm is preferably used. In this way, the surface roughness may be kept sufficiently low so as to guarantee ready coating capability for functional layers. Furthermore, the particle size is to be chosen to be smaller, the thinner the carrier substrate is to be configured. After the sintering process, the porous substrate has a porosity of preferably 20 to 60%, in particular of 40 to 50%. Said porous substrate preferably has a thickness in the range of 170 μm to 1.5 mm, in particular in the range of 250 μm to 800 μm.

According to one refinement, the carrier substrate below the gas-tight surface portion (that is to say in the direction towards the second side) and below the welding zone of the welded connection is configured so as to be porous. In particular, said carrier substrate in this porous portion is still gas-permeable. In this manner, largely identical material properties of the carrier substrate, from the porous central region which mandatorily is to be configured as gas-permeable, to and including the peripheral region of said carrier substrate, are achieved. Furthermore, a non-gradual transition which carries the risk of material weaknesses and material fatigue, such as fissuring, is avoided. In the case of a powder -metallurgically manufactured carrier substrate it is consequently not necessary for the peripheral region to be compressed in a gas-tight manner as a solid material, this being advantageous in view of the difficult pressing and processing capabilities of powders containing Cr. According to one refinement, the carrier substrate in the porous portion of the peripheral region (that is to say except for the regions of the gas-tight zone) has a porosity which in relation to the porosity of the central region is reduced.

In the case of a powder-metallurgically manufactured carrier substrate, this may be performed, for example, by compressing the peripheral region, in particular by uniaxial pressing or by profiled rolling. Preferably a continuous transition between the central region and the peripheral region is manufactured during the compressing process, on account of which tensions arising in the carrier substrate are avoided. Such reduced porosity which is accompanied by increased density is advantageous for configuring the gas-tight surface portion. If the latter is formed by a cover layer to be applied thereon, for example, the gas-tight configuration thereof is enabled by the reduced porosity and the adherence thereof is improved. However, if the surface portion is manufactured by superficial fusing, the volumetric variation which arises in a localized manner is minimized by the reduced porosity. According to one refinement, the carrier substrate in the porous portion of the peripheral region has a porosity in the range of 3% to 20% (both inclusive), preferably in the range of 4% to 12% (both inclusive). Gas tightness is typically not yet provided within these ranges of porosity.

According to one refinement, the welding zone extends from the first side in the thickness direction to the second side up to a depth t of 20% ≤t ≤80% of the thickness d which the carrier substrate has in the peripheral region. Preferably, the depth t is 30% ≤t ≤50% of the thickness d. Within these ranges, a connection of sufficiently high strength between the housing part and the carrier substrate is achieved, on the one hand, and the energy input during welding is kept low, on the other hand, the carrier substrate at least in portions remaining in the original structure thereof.

According to one refinement, that housing portion of the housing part that is connected by the welded connection is disposed so as to overlap the peripheral region of the carrier substrate, and disposed on the first side of the carrier substrate; in particular, the housing portion in the overlapping region bears in a planar manner on the peripheral region of the carrier substrate. By way of a design embodiment of this type, the mechanical stability of the welded connection between the housing part and the carrier substrate is increased, simultaneously facilitating the welding procedure.

According to one refinement, the welding zone in the thickness direction extends completely through the housing part and only partially into the carrier substrate. In particular, the welding zone extends so as to be substantially perpendicular to the plane of primary extent of the carrier substrate, or along the thickness direction, respectively. This type of welded connection in the case of an overlapping arrangement between the housing part and the peripheral region of the carrier substrate is particularly simply manufacturable in the overlapping region. According to one refinement, the welding zone is configured on the periphery of the carrier substrate and/or on the periphery of the housing part, and in the thickness direction extends only through part of the thickness of the housing part. In particular, said welding zone, in the thickness direction extends up to a depth T of 20% ≤T ≤80% of the thickness of the housing part in the region to be connected, the depth T preferably being 30% ≤T ≤50% of this thickness. In this way, the energy input during welding may be kept particularly low, on account of which the risk of warping of the components is reduced even further.

According to one refinement, the housing part is configured in a frame-type manner, extending in an encircling manner around the peripheral region of the carrier substrate. In this manner, encircling gas-tight bonding of the carrier substrate assembly, mechanical mounting of the latter, and electrical contact of said carrier substrate assembly are guaranteed in a reliable and mechanically stressable manner. According to one refinement, the housing part is a sheet-metal frame plate which is provided with gas-passage openings, the sheet-metal frame plate in the region of the external periphery thereof being connected to an interconnector, this being in particular a gas-tight connection (for example, a welded connection, optionally also having an overlapping region between the sheet-metal frame plate and the interconnector). The gas-passage openings here serve for supplying and discharging the process gases. The interconnector which likewise is part of the housing is disposed in the stack between two carrier substrate assemblies which in each case are disposed on top of one another and which each have an electro-chemical cell. Said interconnector, by means of a structure (for example, burl-shaped, rib-shaped, or wave-shaped) on either side establishes the supply and discharge of the process gases across substantially the entire area of the electro -chemical cell, or of the central region of the carrier substrate, respectively. Furthermore, adjacent carrier substrate assemblies which each have one electro-chemical cell are electrically intercontacted in series by way of said interconnector. Preferably, the interconnector is also formed by a correspondingly formed metallic sheet-metal plate part. A gas-tight gas space on the one side of the electrolyte, in particular on that side that faces the associated carrier substrate, is thus achieved in that the carrier substrate assembly is bonded to the frame-shaped housing part in an encircling and gas-tight manner, the frame-shaped housing part in turn being bonded to the interconnector in an encircling and gas-tight manner. This means that a type of housing is formed by the frame-shaped housing part and by the interconnector, and that a gas- tight process-gas space is implemented in this way. Sealing and establishing the respective desired routing of gas in the region of the gas-passage openings is typically obtained by separate inserts, seals, and by the targeted application of sealing compound (for example, glass solder).

A second alternative lies in that the carrier substrate is bonded directly in a gas-tight manner to the interconnector which after all likewise forms a housing part and can be configured so as to correspond to the features which here above have been described with reference to the interconnector. In the case of this variant, the peripheral region of the carrier substrate which is configured in a correspondingly larger manner, would assume the function of the frame-shaped housing part, as has been described above; in particular, the gas-tight surface portion would extend from the layered construction up to the welded connection by way of which the peripheral region is connected to the interconnector (housing part). Preferably, the gas-passage openings which by means of punching, cutting, embossing, or comparable methods, for example, are incorporated into the peripheral region, would also be provided in the peripheral region. Preferably, the (for example, cylindrical) walls of the gas-passage openings, which are configured within the carrier substrate, are also configured so as to be gas -tight. In particular, the gas-tight walls of the gas -passage openings are contiguous in a gas-tight manner to the gas-tight surface portion which, after all, is configured in an encircling manner around the gas-passage openings, on account of which routing of the process gas without leakage is guaranteed. A gas-tight configuration of the walls of the gas-passage openings is achieved in that, for example, these gas-passage openings are incorporated by means of thermal processes such as laser-beam cutting, electron-beam cutting, ion-beam cutting, water-jet cutting, or frictional edge cutting, as these processes lead to superficial fusing of the carrier substrate material, on account of which after solidification a gas-tight portion which extends superficially along the walls and which has a melt phase of the carrier substrate material, and in particular is formed completely from a melt phase of the carrier substrate material, is obtained.

A third variant lies in that the peripheral region of the carrier substrate in the manner as has been illustrated here above is provided with gas-passage openings, and outside the gas-passage openings is bonded to a frame -shaped housing part in an encircling and gas-tight manner. In this instance, the frame-shaped housing part is bonded to an interconnector in an encircling and gas-tight manner, as has been described here above with reference to the first variant.

According to one refinement, the gas-tight surface portion has an electrolyte which is part of the layered construction and on the first side of the carrier substrate extends beyond the layered construction. In particular, said electrolyte extends up to the welded connection. Said electrolyte typically has a thickness in the range of 2 to 10 μm, preferably of 3 to 5 μm. Said electrolyte may also extend beyond the welded connection, in particular up to an external periphery of the carrier substrate (the heat transfer during establishment of the welded connection at the stated thickness range of 3 to 5 μm is not appreciably influenced by the electrolyte). In that the electrolyte has the required gas-tight properties and is required for implementing the layered construction, it is advantageous to employ said electrolyte for implementing the entire gas -tight surface portion, or else only a part thereof.

According to one refinement, the gas-tight surface portion has a superficial gas-tight portion of the carrier substrate, which gas-tight portion is formed from the carrier substrate material and comprises a melt phase of the carrier substrate material. This is achieved in particular by means of a surface post-treatment step leading to the formation of a melt phase of the material of the carrier substrate in a region of the carrier substrate that is close to the surface. Such a surface post-treatment step may be obtained by localized superficial fusing of the porous carrier substrate material, that is to say by brief localized heating to a temperature which is higher than the melting temperature, and may be performed by means of mechanical, thermal, or chemical method steps, for example by means of abrading, blasting, or applying laser beams, electron beams, or ion beams. Preferably a superficial portion which has the melt phase is obtained by impacting bundled beams of high-energy photons, electrons, ions, or of other suitable focussable energy sources, onto the surface of the peripheral region until a specific impact depth has been reached. By way of localized fusing and of rapid cooling after fusing, a modified metallic structure having imperceptible or extremely minor residual porosity, respectively, is formed in this region. This modified structure which has a melt phase, is readily distinguishable from that of the carrier substrate, which is distinguished by a sintered structure, for example in an image from an illuminated microscope or an image from a scanning electron microscope (SEM) of a micrograph of a cutting face through the carrier substrate that is configured along the thickness direction. Fusing may be performed once or else multiple times in sequence. The fusing depth here is to be adapted to the requirement of gas tightness; a fusing depth of at least 1 μm, in particular of 15 μm to 50 μm (both inclusive), particularly preferably of 20 μm to 40 μm (both inclusive), has been found to be suitable. Therefore, the superficial portion which has the melt phase, measured from the surface of the carrier substrate, extends by this fusing depth into the carrier substrate. Other phases, for example, amorphous structures, may also be present in the superficial portion which has the melt phase alongside the melt phase. Particularly preferably, that superficial portion that has the melt phase is formed completely from the melt phase of the carrier substrate material. The fusing process leads to a very smooth surface of low surface roughness. This permits ready coating capability for functional layers such as an electrolyte layer which, proceeding from the layered construction, preferably extends at least across part of that superficial portion that has the melt phase. Such a surface post-treatment step is described in WO 2014/187534 A1, for example.

According to one refinement, the gas-tight surface portion has a gas-tight sealing compound which is applied on the carrier substrate such as, for example, a glass solder, a metal solder, or an inorganic paste which optionally also only cures during operation of the electro-chemical module.

The gas-tight surface portion may also be formed by a plurality of gas-tight portions, in particular from a combination of an electrolyte, of a gas-tight superficial portion of the carrier substrate that is formed from the carrier substrate material and has a melt phase, and/or of a gas-tight sealing compound. In relation to the plane of primary extent of the plate-shaped carrier substrate, these portions may also be configured so as to be on top of one another in multiple layers; optionally, however, such overlapping regions may also be provided only in portions.

The present invention furthermore relates to a method for manufacturing an electro-chemical module, the method having the following steps:
A) powder metallurgical manufacturing of a porous plate-shaped metallic carrier substrate which at least in a central region which is surrounded by a peripheral region is configured so as to be gas -permeable;
B) gas-tight bonding of a layered construction to at least one metallic gas-tight housing part on a first side of the carrier substrate,
in that the layered construction comprising at least one electro-chemically active layer in the central region is applied on the first side of the carrier substrate,
in that the at least one metallic gas-tight housing part by way of a welded connection is connected to the peripheral region of the carrier substrate in such a manner that the welding zone, proceeding from the first side, in the thickness direction extends only through part of the thickness of the carrier substrate to an opposite second side of the carrier substrate, and
in that a gas-tight surface portion which extends superficially from the layered construction on the first side of the carrier substrate up to the welded connection is configured.

By way of the method according to the invention, the identical advantages as have been described here above with reference to the electro-chemical module according to the invention are substantially achievable. The refinements and optional additional features which have been described here above with reference to the electro-chemical module are also implementable in a corresponding manner in the context of the presently claimed manufacturing method, leading to the abovementioned advantages. The individual steps which are to be carried out in the context of “gas-tight bonding” (cf. step B)) here may be carried out in a different sequence. If the gas-tight surface portion is to extend beyond the welded connection in the direction towards the external periphery of the carrier substrate, the gas-tight surface portion is then preferably to be configured prior to the housing part by way of a welded connection being connected to the peripheral region of the carrier substrate.

In order for the porosity of the various regions of the carrier substrate to be determined, polished cross sections which are perpendicular to the plane of primary extent of the plate-shaped carrier substrate are made in that parts are sawn out of the carrier substrate by means of a diamond-wire saw, these parts are fixed in an embedding means (for example in epoxy resin), and after curing are polished (using successively finer sandpaper). Subsequently, the specimens are polished using a polishing suspension, and finally are electrolyte-polished. These specimens are analysed by means of a scanning electron microscope (SEM) and a BSE (back-scattered electrons) detector (BSE detector and/or 4-quadrant-ring detector). As a scanning electron microscope, the field emission apparatus “Ultra Plus 55” of the Zeiss company was used here. The SEM image within a measured area to be evaluated is in each case evaluated in quantitative terms by means of stereological methods (software used: “Leica QWin”), wherein attention is paid to as homogenous a fragment as possible of the part of the carrier substrate being present within the measured area to be evaluated. The proportion per unit area of pores in relation to the entire measured area to be evaluated is determined in the context of the measurement of porosity. This proportion per unit area simultaneously corresponds to the porosity in % of the volume of pores. Those pores that are only partially within the measured area to be evaluated are not considered in the case of the measuring method. The following settings were used for the SEM image: tilting angle: 0°, acceleration voltage of 20 kV, operating spacing of approx. 10 mm, and a magnification of 250 (as per the apparatus), resulting in a horizontal picture edge of approx. 600 μm . Here, particular value was placed on very good image sharpness.

Further advantages and expediencies of the invention are derived by means of the following description of exemplary embodiments with reference to the appended figures in which, for reasons of visualizing the present invention, the proportions are not always provided to scale.

In the figures:

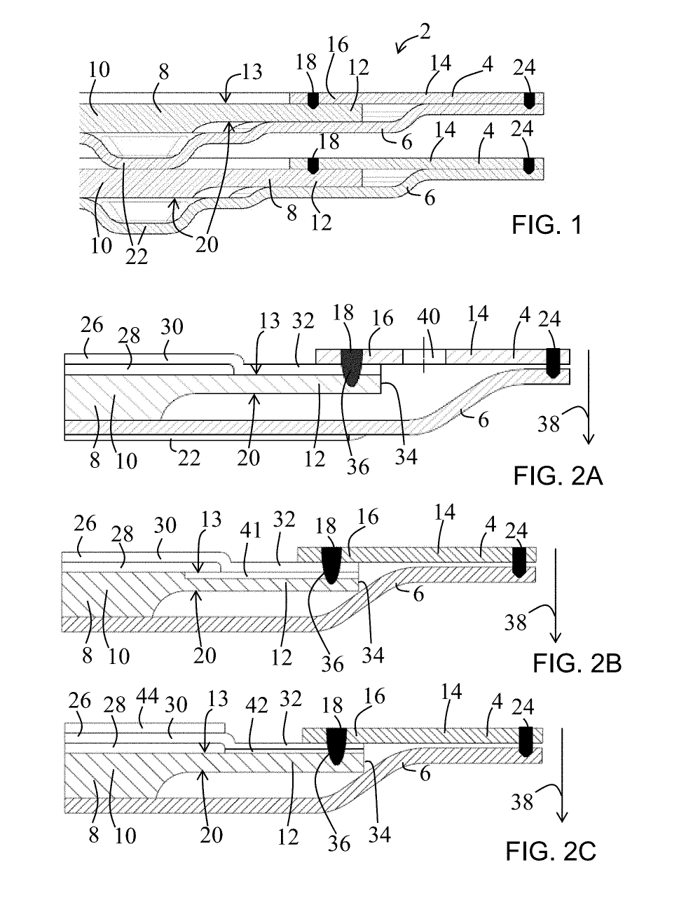

FIG. 1: shows a stack having two electro-chemical modules according to the present invention,

in the cross section;

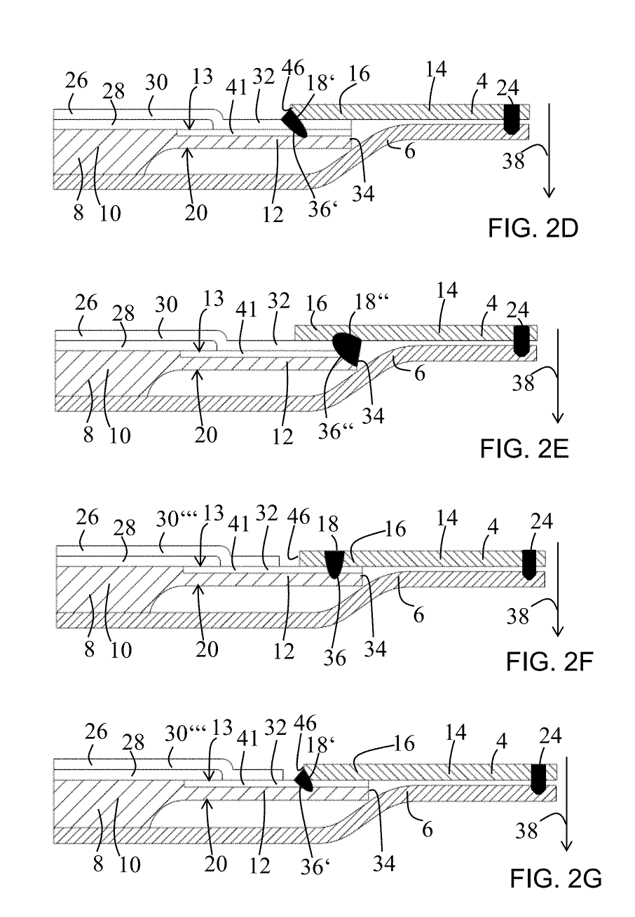

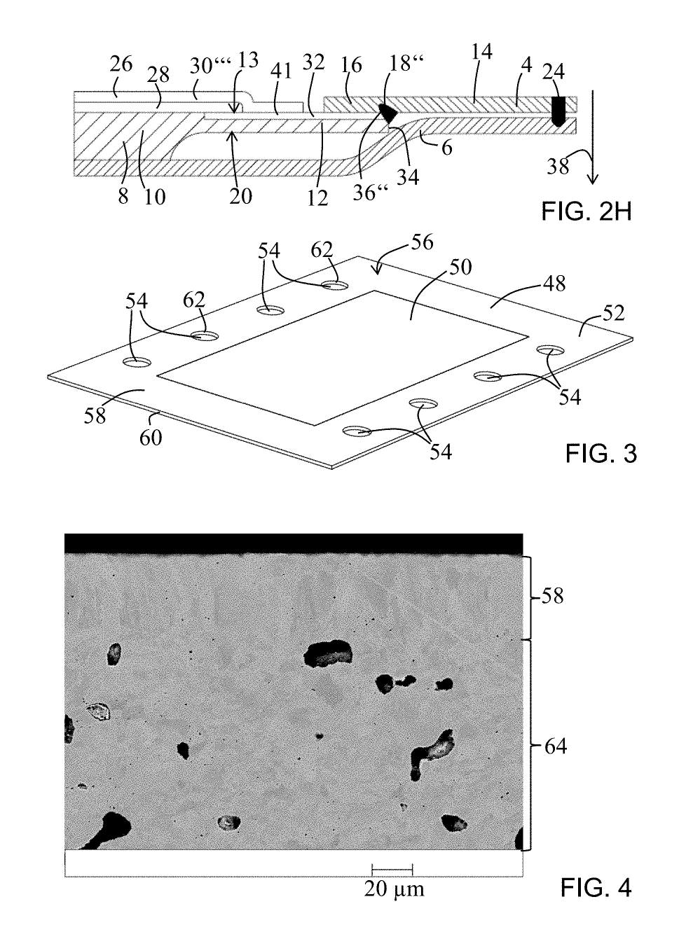

FIGS. 2a-2h: show an electro-chemical module according to the present invention, in the cross section, connected to an interconnector, having in each case different variants of the gas -tight zone;

FIG. 3: shows a metallic carrier substrate having integrated gas-passage openings, in a perspective view;

FIG. 4: shows an SEM image of the peripheral region of a metallic carrier substrate in the polished cross section, having carrier substrate material superficially fused thereto;

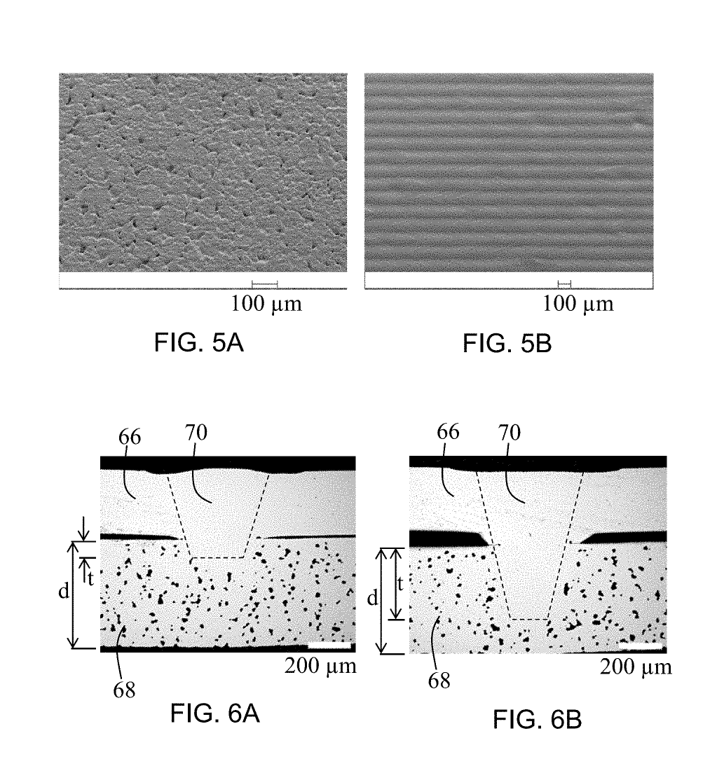

FIGS. 5a-5b: show SEM images of the surface of the peripheral region of a metallic carrier substrate prior to (FIG. 5a) and post (FIG. 5b) superficial fusing; and

FIGS. 6a-6b: show illuminated microscope images of two electro-chemical modules according to the invention in the region of the welding zone in the polished cross section, once having a comparatively low (FIG. 6a) and once having a comparatively great (FIG. 6b) penetration depth of the welding zone.

FIG. 1 in a schematic illustration shows a stack (2) having two electro-chemical modules (4) according to the present invention, each being connected to an interconnector (6). The electro-chemical modules (4) each have a powder -metallurgically manufactured porous plate-shaped metallic carrier substrate (8) having a gas-permeable central region (10) and a peripheral region (12) which in relation to the central region is further compressed, and a metallic sheet -metal frame plate (14) which is placed onto a first side (13) of the carrier substrate (8) and which in the overlapping region of the inner frame region (16) thereof by way of an encircling welded connection (18) is connected to the peripheral region (12) of the carrier substrate (8). The peripheral region (12) here has a lower porosity than the central region (10), the former however still being configured so as to be gas-permeable. On a second side (20) of the carrier substrate (8), the interconnector (6) which in the central region thereof has a ribbed structure (22), in each case bears in portions on the carrier substrate (8), wherein the interconnector (6) and the sheet-metal frame plate (14), each by way of the peripheral regions thereof, bear on one another in an encircling manner and are interconnected in an encircling manner by way of a welded connection (24). The viewing direction in FIG. 1 here runs along the direction of extent of the ribbed structure (22).

The configuration of the layered construction and of the gas-tight zone hereunder will be explained with reference to FIG. 2a which schematically shows the electro-chemical module (4) according to the present invention in the cross section and having a higher degree of detail in the region of the layered construction and of the gas-tight zone (in proportions departing from those of FIG. 1), but presently in the viewing direction which is transverse to the direction of extent of the ribbed structure (22) of the interconnector (6), said electro-chemical module (4) being connected to the interconnector (6). The same reference signs as in FIG. 1 are used for identical or equivalent components. A layered construction (26) which presently has an anode (28) which is disposed on the carrier substrate (8), and an electrolyte (30) which is disposed on the anode (28), is applied in the central region (10) on a first side of the carrier substrate (8), a diffusion barrier layer which is typically provided between the anode (28) and the carrier substrate (8) not being illustrated. A gas-tight zone (32) which extends from the layered construction (26) up to the sheet-metal frame plate (14) is formed in that the gas-tight electrolyte (30) is extended beyond the central region (10) and the anode (28) on the first side (13) along the surface of the carrier substrate (8) into the overlapping region with the sheet-metal frame plate (14) (presently even up to an external periphery (34) of the carrier substrate (8)). An encircling gas-tight transition from the electrolyte (30) to the sheet-metal frame plate (14) is established by the welded connection (18). Proceeding from the first side (13) in the thickness direction (38), a welding zone (36) of the welded connection extends in the direction towards the opposite second side (20) only through part of the thickness of the carrier substrate (8). The direction which is perpendicular to the plane of primary extent of the plate-shaped carrier substrate (8) is referred to here as the thickness direction (38). A gas-passage opening (40) which is configured in the sheet-metal frame plate (14) is furthermore illustrated in FIG. 2a.

Further embodiments of the present invention will be explained hereunder with reference to FIGS. 2b to 2h, the manner of illustration largely corresponding to that of FIG. 2a, except for the ribbed structure (22) of the interconnector (6) and the gas-passage opening (40) not being illustrated. Only the different variants of the configuration of the gas-tight zone will be discussed hereunder, the same reference signs being used for the same components, and the construction being only explained to the extent of differences existing in relation to Figs. la and 2a. In the case of the exemplary embodiment of FIG. 2b, a gas-tight portion (41) of the carrier substrate (8) is additionally configured superficially on the first side (13) in the peripheral region (12) of the carrier substrate (8) and is formed from the carrier substrate material, said portion (41) having a melt phase of the carrier substrate material and extending up to the external periphery (34) of the carrier substrate (8). This gas-tight superficial portion (41) has been manufactured by superficial fusing of the carrier substrate material. Accordingly, two gas-tight layers, specifically the gas-tight electrolyte (30), and the superficial gas-tight portion (41) are disposed on top of one another. In the case of the embodiment of FIG. 2c, a sealing layer (42), which is formed from a gas-tight sealing compound and which likewise extends up to the external periphery (34) of the carrier substrate (8), is provided between the electrolyte (30) and the peripheral region (12) of the carrier substrate (8). In the context of manufacturing, the sealing compound is applied here in the peripheral region (12) on the first side (13) of the carrier substrate (8), prior to the electrolyte material (30) being applied. The gas-tight electrolyte (30) and the sealing layer (42) form two gas-tight layers which are configured on top of one another. A further modification in relation to FIG. 2a lies in that in the case of the electro-chemical module of FIG. 2c, a cathode (44) is already provided above the electrolyte (30), a diffusion barrier layer which is typically provided between the electrolyte (30) and the cathode (44) not being illustrated. In a modification in relation to FIG. 2b, the welding zone (36′) of the welded connection (18′) in Fig. 2d is configured in an encircling manner on the internal periphery (46) of the sheet-metal frame plate (14), extending in the thickness direction (38) only through part of the thickness of the sheet-metal frame plate (14) (and accordingly also only through part of the thickness of the carrier substrate (8)). In a modification in relation to FIG. 2b, the welding zone (36″) of the welded connection (18″) in FIG. 2e is configured in an encircling manner on the external periphery (34) of the carrier substrate (8), extending in the thickness direction (38) only through part of the thickness of the sheet-metal frame plate (14) (and accordingly also only through part of the thickness of the carrier substrate (8)). In a modification in relation to FIG. 2b, the electrolyte (30′″) in FIG. 2f likewise extends beyond the central region (10) and the anode (28) on the first side (13) along the surface of the carrier substrate (8), however said electrolyte (30′″) terminates prior to reaching the internal periphery (46) of the sheet -metal frame plate (14) and prior to reaching the welded connection (18). Additionally, a superficial gas-tight portion (41) corresponding to that shown in FIG. 2b is provided. Accordingly, two gas-tight layers disposed on top of one another are only provided in portions. The same modification as has been explained with reference to FIG. 2f is provided in FIG. 2g, however as a modification in relation to FIG. 2d. The same modification as has been explained with reference to FIG. 2f is provided in FIG. 2h, however as a modification in relation to FIG. 2e. As is evident by means of FIGS. 2a to 2h, there are still further possibilities for combining the parameters of the number and construction of the layered stack, configuring the electrolyte, configuring a superficial gas-tight portion, configuring a sealing layer, and configuring and placing the welding zone. In particular, one to three gas-tight layers (electrolyte, sealing layer, superficial gas-tight portion) may be provided, for example, which overlap completely or else only in part.

A further variant of a powder-metallurgically manufactured porous plate-shaped metallic carrier substrate (48) having a gas-permeable central region (50), on which a layered stack is capable of being applied, and having a peripheral region (52) which in relation to the central region is further compressed is shown in FIG. 3. The peripheral region (52) here has a porosity which is lower than that of the central region (50), but is still configured so as to be gas-permeable. Gas-passage openings (54) which are along two mutually opposite sides and which each extend through the peripheral region (52) are provided in the peripheral region (52). A superficial gas-tight portion (58) of the carrier substrate (48) which is formed from the carrier substrate material and which has a melt phase of the carrier substrate material, is configured on the first side (56), that is to say that side which faces the layered stack to be applied, this portion (58) extending up to the external periphery (60) of the carrier substrate (48). This superficial gas-tight portion (58) has been manufactured by superficially fusing the carrier substrate material. The cylindrical walls (62) of the gas-passage openings (54) are also configured so as to be gas-tight, this being achievable by incorporating the former by means of laser cutting, for example. The walls (62) are contiguous in a gas-tight manner to the superficial gas-tight portion (58).

A superficial gas-tight portion (58) which is manufactured by means of laser processing, for example, is distinguishable from the porous portion (64) lying therebelow by means of the microstructure (presently: the melt phase) as well as by means of the difference in porosity, as can be seen by means of the SEM image of FIG. 4. By means of the SEM images of FIGS. 5a and 5b of the surface of a powder-metallurgically manufactured and precompressed peripheral region prior to (FIG. 5a) and post (FIG. 5b) laser processing for manufacturing the superficial gas-tight portion it can be seen that the surface roughness is significantly reduced, also leading to improved adhering properties of the electrolyte or else to a sealing layer. The fragment of the welded connection between a sheet-metal frame plate (66) and a porous powder -metallurgical carrier substrate (68) in the polished cross section is shown in each case in FIGS. 6a and 6b. The welding zone (70) of the welded connection in one instance extends to a depth t of approx. 20% (FIG. 6a) and in one instance to a depth t of approx. 70% (FIG. 6b) of the thickness d of the carrier substrate (68) in the respective region (including a range of variance of approx. ±5%). The welding parameters for the welded connection of FIG. 6a were P=550 W, z_{f}=0 mm, ∅_{fibre}=400 μm , ∅ₛₚₒₜ=400 μm, vₛ=4 m/min (min: minute), those for FIG. 6b were P=600 W, z_{f}=0 mm, ∅_{fibre}=400 μm , ∅ₛₚₒₜ=400 μm, vₛ=4 m/min, wherein P is the laser output, z_{f} is the focal position, ∅_{fibre} is the fibre diameter, ∅ₛₚₒₜ is the spot diameter, and vₛ is the beam velocity.

Manufacturing Example:

Using corresponding primary powders having a total composition and particle size as has been stated here above in the context of AT 008 975 U1, a carrier substrate has been manufactured in a powder-metallurgical way (i.e. comprising the steps of pressing the primary powder and of sintering). Thereafter, the carrier substrate had a thickness of 0.8 mm and a porosity of approx. 45% by volume. After the sintering process and after cutting to the desired format, the substrate with the aid of a uniaxial press having up to 1500 t of pressing force is compressed in the encircling peripheral region. After this process step, this compressed peripheral region has a residual porosity of 8% by volume. Subsequent to compressing, this peripheral region with the aid of a disc laser and 3D laser optics which are adapted thereto on the first side is superficially fused. A laser output of 150 W at a beam velocity of 400 mm/s at a spot diameter of 150 μm was used as parameter for this processing step. The area to be processed (presently the entire surface of the peripheral region on the first side) is covered in a meandering manner, such that the entire area is processed. The application of a diffusion barrier layer composed of cerium-gadolinium oxide by means of a PVD process, such as magnetron sputtering, for example, is then performed. After this treatment step, the anode, required for the electro -chemically active cell (when operating as a fuel cell), which is from a composite composed of nickel and zirconium dioxide fully stabilized with yttrium oxide is applied by screen printing. The multi-layered graded anode here terminates on the superficially fused peripheral region of the carrier substrate such that an overlapping region is formed. The anode is sintered by way of a sintering step in a reduced atmosphere and at T>1000° C. Subsequently, the electrolyte layer of zirconium dioxide fully stabilized with yttrium oxide is applied thereon across the entire area by way of a PVD process (gas flow sputtering). For the use of electrode materials having mixed conductivity, such as, for example, LSCF ((La,Sr)(Co,Fe)O₃), a diffusion barrier (cerium-gadolinium oxide) is additionally required. The latter may be likewise applied very thinly by way of a PVD process (for example, by magnetron sputtering). After measuring the specific leakage rate according to the differential pressure method, the electrode material LSCF((La,Sr)(Co,Fe)₃) is applied. This usually is likewise performed by way of a screen printing step. Sintering required for the cathode layer is performed in situ when the electro-chemical cell is put into operation. Thereafter, the electro-chemical cell is ready for integration into a sheet-metal frame plate. The coated carrier substrate here is positioned with the aid of a device. The sheet-metal frame plate by way of a respective cutout is now tension-fitted so as to be as free of any gap as possible onto this carrier substrate on the (first) side on which the layered stack is also disposed. The encircling weld seam is likewise implemented with the aid of 3D scanning optics and of a disc laser. The laser output has to be adapted so as to correspond to the thickness of the carrier substrate and of the sheet-metal frame plate. The electro-chemical cell according to this application may be integrated using the set parameters of 600 W laser output, 400 μm spot diameter, and 4000 mm/min beam velocity.

1-15. (canceled)

16. An electro-chemical module, comprising:
a porous plate-shaped metallic carrier substrate having a gas-permeable central region, a peripheral region surrounding said central region, a first side and a second side;
a layered construction having at least one electro-chemically active layer, said layered construction disposed in said central region on said first side of said carrier substrate;
a welded connection having a welding zone;
at least one metallic gas-tight housing part connected by way of said welded connection to said peripheral region of said carrier substrate;
a gas-tight zone extending from said layered construction up to said metallic gas-tight housing part, said gas-tight zone having a gas-tight surface portion extending superficially from said layered construction on said first side of said carrier substrate at least up to said welded connection; and
said welded connection by which said gas-tight surface portion is connected in a gas-tight manner to said metallic gas-tight housing part and said welding zone, proceeding from said first side, in a thickness direction extends only through part of a thickness of said carrier substrate to an opposite said second side of said carrier substrate.

17. The electro-chemical module according to claim 16, wherein said carrier substrate below said gas-tight surface portion and below said welding zone of said welded connection is configured so as to be porous.

18. The electro-chemical module according to claim 17, wherein said carrier substrate in a porous portion of said peripheral region has a porosity which in relation to a porosity of said central region is reduced.

19. The electro-chemical module according to claim 16, wherein said carrier substrate is integrally manufactured in one piece by powder metallurgical means from a material combination which is based on at least one fo chromium or iron.

20. The electro-chemical module according to claim 17, wherein said carrier substrate in a porous portion of said peripheral region has a porosity in a range of 3% to 20%.

21. The electro-chemical module according to claim 16, wherein said welding zone extends from said first side in said thickness direction toward said second side up to a depth t where 20% ≤t ≤80% of said thickness which said carrier substrate has in said peripheral region.

22. The electro-chemical module according to claim 16, wherein said housing part has a housing portion connected by said welded connection, said housing portion is disposed so as to overlap said peripheral region of said carrier substrate and disposed on said first side of said carrier substrate.

23. The electro-chemical module according to claim 16, wherein said welding zone in the thickness direction extends completely through said housing part and only partially into said carrier substrate.

24. The electro-chemical module according to claim 16, wherein said welding zone is configured on a periphery of said carrier substrate and/or on a periphery of said housing part, and in the thickness direction extends only through part of a thickness of said housing part.

25. The electro-chemical module according to claim 16, wherein said housing part is configured in a frame-type manner, extending in an encircling manner around said peripheral region of said carrier substrate.

26. The electro-chemical module according to claim 16,
further comprising an interconnector; and
wherein said housing part is a sheet-metal frame plate having gas-passage openings formed therein, said sheet-metal frame plate in a region of an external periphery thereof being connected to said interconnector.

27. The electro-chemical module according to claim 16, wherein said gas-tight surface portion has an electrolyte which is part of said layered construction and on said first side of said carrier substrate extends beyond said layered construction.

28. The electro-chemical module according to claim 16, wherein said gas-tight surface portion is a superficial gas-tight portion formed in said carrier substrate, said superficial gas-tight portion is formed from a carrier substrate material and contains a melt phase of said carrier substrate material.

29. The electro-chemical module according to claim 16, wherein said gas-tight surface portion has a gas-tight sealing compound which is applied on said carrier substrate.

30. A method for manufacturing an electro-chemical module, which comprises the steps of:
powder metallurgical manufacturing a porous plate-shaped metallic carrier substrate having a central region being surrounded by a peripheral region and at least the central region being configured so as to be gas-permeable;
gas-tight bonding a layered construction to at least one metallic gas-tight housing part on a first side of the carrier substrate, the layered construction having at least one electro-chemically active layer in the central region applied on the first side of the carrier substrate, the at least one metallic gas-tight housing part by way of a welded connection is connected to the peripheral region of the carrier substrate such that a welding zone, proceeding from the first side, in a thickness direction extending only through part of a thickness of the carrier substrate to an opposite second side of the carrier substrate; and
configuring a gas-tight surface portion extending superficially from the layered construction on the first side of the carrier substrate up to the welded connection.
